(19) United States
(12) Patent Application Publication
(10) Pub. No.: US 2013/0294108 A1
(43) Pub. Date: Nov. 7, 2013

(54) OPTICAL FILM AND BACKLIGHT MODULE USING THE SAME

(71) Applicants: Ya-Wen HU, Kaohsiung City (TW); Jui-Wen PAN, Hsinchu City (TW)

(72) Inventors: Ya-Wen HU, Kaohsiung City (TW); Jui-Wen PAN, Hsinchu City (TW)

(73) Assignee: NATIONAL CHIAO TUNG UNIVERSITY, Hsinchu City (TW)

(21) Appl. No.: 13/604,643

(22) Filed: Sep. 6, 2012

(30) Foreign Application Priority Data
May 3, 2012 (TW) 101115779

(51) Int. Cl. F21V 8/00; G02B 27/30

(52) U.S. Cl. 362/613; 359/641; 362/611; 362/627

(57) ABSTRACT

An optical film applied in a backlight module is provided. The optical film includes a basic layer, a plurality of periodically arranged reflective convex-parts and a plurality of periodically arranged collimating parts. The reflective convex-parts are disposed on the first surface of the basic layer. The reflective convex-part includes at least one reflective side surface and an incident bottom surface contacting a light guide plate. The collimating parts are disposed on the second surface of the basic layer. The reflective convex-parts are respectively corresponded to the collimating parts. In each corresponding pair of the reflective convex-part and the collimating part, a central axis of the reflective convex-part is substantially coincided with a central axis of the collimating part. In addition, a backlight module using the optical film is also provided.

### RELATED APPLICATIONS

This application claims priority to Taiwan Application Serial Number 101115779, filed May 3, 2012, which is herein incorporated by reference.

### BACKGROUND

1. Technical Field

The present disclosure relates to an optical film, and more particularly, to an optical film applied in a backlight module and a backlight module using the optical film.

2. Description of Related Art

Generally, since a liquid crystal display device is a non-self-illuminating display device, a backlight module is required to provide a light source for the display device. Depending on the relative position between the light source and a light-emitting surface, the backlight modules can be classified into two categories: a side-edge backlight module and a direct-type backlight module.

The side-edge backlight module typically includes a light source, a light guide plate and a number of optical components such as a reflector, a diffusion sheet and a secondary component. The diffusion sheet and the secondary component are sequentially disposed on the light guide plate to respectively cover defects thereof and collimate light emitted from the diffusion sheet. A backlight system exhibiting high collimation can effectively increase energy in an effective area of observation and further improve efficiency. The reflector disposed beneath the light guide plate is used to reflect light emitted from the bottom of the light guide plate back into the light guide plate. However, such backlight module would generate large Fresnel loss, and collimation thereof still needs to be improved.

The direct-type backlight module is to directly place a light source beneath a panel. The direct-type backlight module exhibits high uniformity and higher brightness in light emitting. Also, a large number of light sources are used in the direct-type backlight module, which would result in high cost and power consumption. Therefore, the side-edge backlight module has become the mainstream in the current market of personal compact- and medium-sized products.

Given the above, there is a need for an optical film that can help reduce the number of components in a side-edge backlight module and exhibit high collimation to solve the problem mentioned above.

### SUMMARY

One aspect of the present disclosure provides an optical film. The optical film includes a basic layer, a plurality of periodically arranged reflective convex-parts and a plurality of periodically arranged collimating parts. The reflective convex-parts are disposed on the first surface of the basic layer. Each of the reflective convex-parts includes at least one reflective side surface and an incident bottom surface. An included angle between the reflective side surface and the first surface is from 20 to 80 degrees. The incident bottom surface is substantially paralleled to the first surface for contacting a transmittance element. The collimating parts are disposed on the second surface of the basic layer. The reflective convex-parts are respectively corresponded to the collimating parts. In each corresponding pair of the reflective convex-part and the collimating part, a central axis of the reflective convex-part is substantially coincided with a central axis of the collimating part.

According to one embodiment of the present disclosure, a backlight module is provided, which includes the optical film mentioned above. Also, the transmittance element is a light guide plate.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The disclosure may be more fully understood by reading the following detailed description of the embodiment, with reference made to the accompanying drawings as follows:

FIGS. 1A-1B are schematic diagrams of an optical film and a light guide plate according to one embodiment of the present disclosure;

FIGS. 2A-2B are schematic diagrams of reflective convex-parts according to embodiments of the present disclosure;

FIG. 3 is a schematic diagram of an optical film according to another embodiment of the present disclosure;

FIGS. 4A-4C are scheme diagrams of light paths through a light guide plate and an optical film according to one embodiment of the present disclosure;

FIG. 5 is a cross-sectional view of a backlight module according to one embodiment of the present disclosure;

FIG. 6 is a schematic diagram of a backlight module according to one embodiment of the present disclosure;

FIG. 7 is an illumination of a backlight module with a single-sided light source according to one embodiment of the present disclosure;

FIGS. 8A, 8B and 8C are intensity charts of a backlight module according to one embodiment of the present disclosure, a conventional backlight module, and a backlight module having V-cut design, respectively;

FIG. 9 is a relationship diagram between normalized luminance and off-axis angle of a backlight module according to one embodiment of the present disclosure, a conventional backlight module and a backlight module having V-cut design;

FIG. 10 is an illumination of a backlight module with a double-sided light source according to one embodiment of the present disclosure;

FIG. 11 is an intensity chart of a backlight module with a double-sided light source according to one embodiment of the present disclosure;

FIG. 12 is a relationship diagram between normalized luminance and off-axis angle of a backlight module with a single-sided light source and another backlight module with a double-sided light source according to embodiments of the present disclosure;

FIG. 13 is a schematic diagram of shift values, which are between a reflective convex-part and a collimating part respectively in vertical and horizontal directions, θₘₐₓ and θₕ according to one embodiment of the present disclosure; and

FIGS. 14A-14B are relationship diagrams of shift values, which are between a reflective convex-part and a collimating part respectively in vertical and horizontal directions, θₘₐₓ and θₕ according to one embodiment of the present disclosure.

### DETAILED DESCRIPTION

The present disclosure is described by the following specific embodiments. Those with ordinary skill in the arts can readily understand the other advantages and functions of the present invention after reading the disclosure of this specification. The present disclosure can also be implemented with different embodiments. Various details described in this specification can be modified based on different viewpoints and applications without departing from the scope of the present disclosure.

As used herein, the singular forms “a,” “an” and “the” include plural referents unless the context clearly dictates otherwise. Therefore, reference to, for example, a data sequence includes aspects having two or more such sequences, unless the context clearly indicates otherwise.

Reference will now be made in detail to the embodiments of the present disclosure, examples of which are illustrated in the accompanying drawings. Wherever possible, the same reference numbers are used in the drawings and the description to refer to the same or like parts.

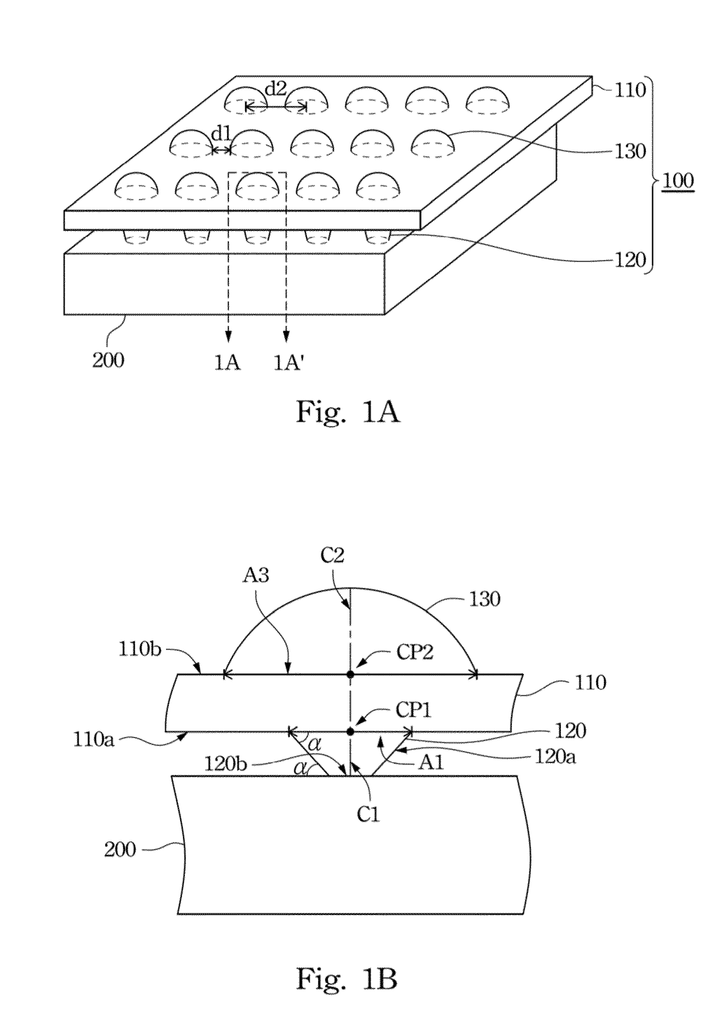

One aspect of the present disclosure provides an optical film 100 including a basic layer 110, a plurality of periodically arranged reflective convex-parts 120 and a plurality of periodically arranged collimating parts 130, as shown in FIG. 1A. The reflective convex-parts 120 and the collimating parts 130 are respectively disposed on a first surface 110a and a second surface 110b of the basic layer 110, as shown in FIG. 1B. FIG. 1B is a cross-sectional view along line 1A-1A′ of FIG. 1.

The optical film 100 is used to collimate light and placed on a light guide plate 200. Light penetrating a side of the light guide plate 200 would be totally reflected and moved forward therein. Consequently, there is no need to dispose a reflector beneath the light guide plate 200. When light contacts the bottom of the reflective convex-parts 120, it would move into the reflective convex-parts 120 and then be reflected to penetrate the basic layer 110. Sequentially, light would be converged, collimated and then emitted to outside by the collimating parts 130.

In one embodiment, the basic layer 110, the reflective convex-parts 120, the collimating parts 130 and the light guide plate 200 are made of a same material, such as poly(methylmethacrylate) (PMMA). The optical film 100 and the light guide plate 200 made of the same material can avoid generation of Fresnel loss.

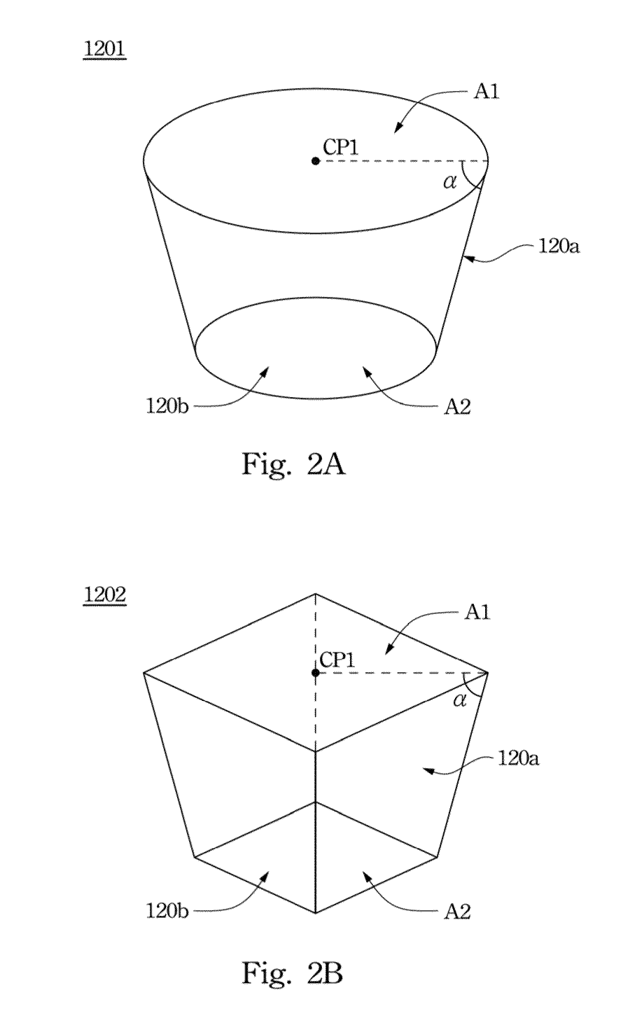

The reflective convex-parts 120 are disposed on the first surface 110a of the basic layer 110, as depicted in FIG. 1B. Each of the reflective convex-parts 120 includes at least one reflective side surface 120a and an incident bottom surface 120b. The reflective convex-part 120a is utilized to totally reflect light and then transmit it into the basic layer 110 and the collimating part 130 in sequence, without allowing light to penetrate the reflective side surface 120a to outside. Consequently, there is an included angle α between the reflective side surface 120a and the first surface 110a being from 20 degrees to 80 degrees. In one embodiment, the included angle α between the reflective side surface 120a and the first surface 110a being from 40 degrees to 60 degrees. The “included angle” refers to the angle between a contacting area A1 between the reflective convex-parts 120 and the first surface 110a, and the reflective side surface 120a. In one embodiment, the contacting area A1 between the reflective convex-part 120 and the first surface 110a is greater than an area A2 of the incident bottom surface 120b, as shown in FIG. 2A.

In one embodiment, the reflective convex-part 120 is a truncated taper, as depicted in FIGS. 2A-2B. In one embodiment, the truncated taper is a truncated cone 1201, as shown in FIG. 2A. In another embodiment, the truncated taper is a truncated pyramid 1202, which has four reflective side surfaces 120a, as shown in FIG. 2B.

The incident bottom surface 120b is substantially paralleled to the first surface 110a, which is used to contact the upper surface of the light guide plate 200, as depicted in FIG. 1B. Therefore, when light being totally reflected and moved in the light guide plate 200 contacts the bottom of the reflective convex-parts 120, it would move thereinto. That is to say, the reflective convex-parts 120 is utilized to destruct total reflection of light in the light guide plate 200.

The collimating parts 130 are disposed on the second surface 110b of the basic layer 110, and the reflective convex-parts 120 are respectively corresponded to the collimating parts 130, as shown in FIG. 1B. The collimating parts 130 are used to converge and collimate light.

In each corresponding pair of the reflective convex-part 120 and the collimating part 130, a central axis C1 of the reflective convex-part 120 is substantially coincided with a central axis C2 of the collimating part 130. Light totally reflected in the reflective convex-part 120 need to be transmitted to the basic layer 110 and the collimating part 130, such that the reflective convex-part 120 should be substantially coincided with the collimating part 130. In other words, a vertical projection of the reflective convex-part 120 to the basic layer 110 should be overlapped with a vertical projection of the collimating part 130 to the basic layer 110. Preferably, a central point CP1 of the vertical projection of the reflective convex-part 120 and a central point CP2 of the vertical projection of the collimating part 130 are located in a same axis. Hence, light reflected from each of the reflective convex-part 120 all could be then converged and collimated by each of the corresponding collimating part 130, such that the optical film 100 can exhibit good collimation.

In one embodiment, the reflective convex-part 120 has a surface A1 contacting the first surface 110a less than a surface A3 of the collimating part 130 which contacts the second surface 110b, as shown in FIG. 1B. It is because light totally reflected in the reflective convex-part 120 should all be transmitted into the collimating part 130. If the area A3 less than the area A1, some light totally reflected in the reflective convex-part 120 would directly transmit the basic layer 110 to outside and without through the collimating part 130.

Further, the corresponding pairs of the reflective convex-parts 120 and the collimating parts 130 control direction of light, such that changing distribution density of the reflective convex-parts 120 and the collimating parts 130 can adjust illumination distribution. According to arrangement of the collimating parts 130, it can be classified into two categories: spatially arranged and side-by side. In one embodiment, a distance d₁ between one collimating part 130 and another collimating part 130 close thereto is from 0 mm to 0.1 mm. In one embodiment, a distance d₂ between a central point of the collimating part 130 and a central point of another collimating part 130 close thereto is from 0.2 mm to 0.3 mm.

In one embodiment, the collimating parts 130 are arranged side-by-side, as shown in FIG. 1A.

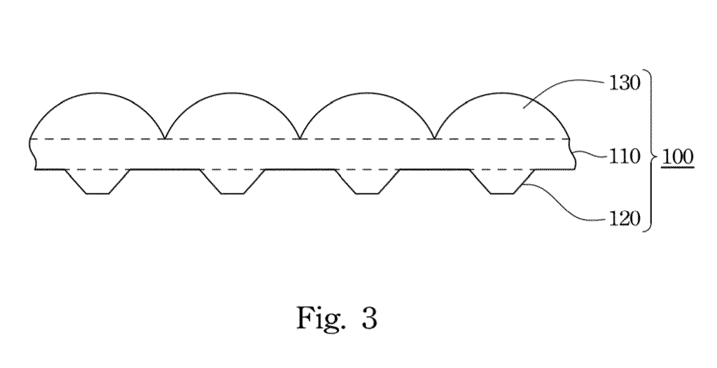

In one embodiment, the collimating parts 130 are spatially arranged, as shown in FIG. 3. That is to say, the distance d₁ between the collimating part 130 and another collimating part 130 close thereto is 0.

In one embodiment, the collimating part 130 is a collimating lens, and it is not limited to any shape. In one embodiment, the collimating lens is a spherical lens.

How to design the structure of the optical film by the principle of a light path will be described below.

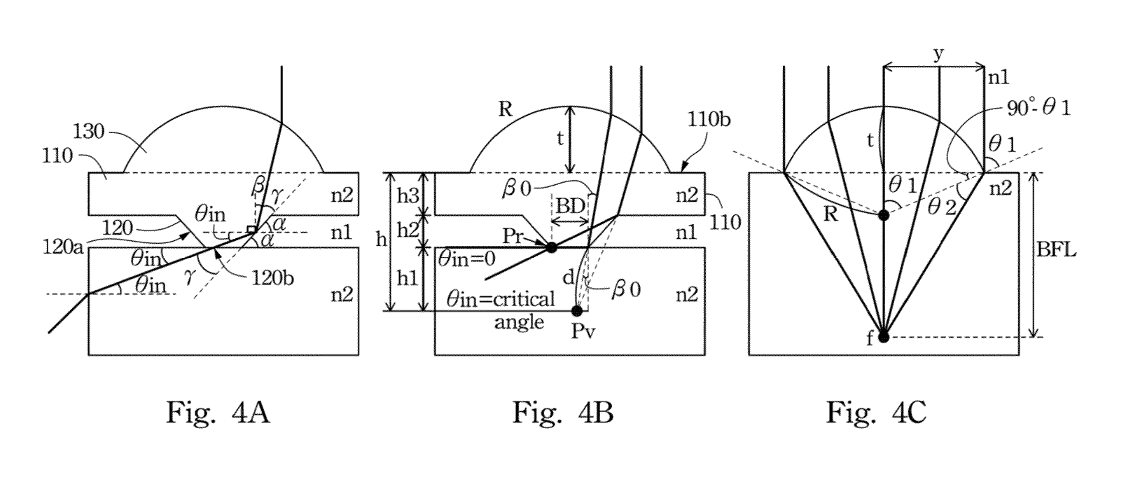

As shown in FIG. 4A, when light enters a position between the light guide plate 200 and the incident bottom surface 120b, light would enter into the reflective convex-part 120 and then be reflected by the reflective side surface 120a. The relationship is depicted in formulas (1) to (3):

$$\begin{matrix}γ = α - {θ}_{m} 0 \leq {θ}_{m} \leq {sin}^{- 1} ( 1 \text{/} n ) & ( 1 ) \\ α + β + γ = {90}^{°} & ( 2 ) \\ \begin{matrix}β = {90}^{°} - α - γ \\ = {90}^{°} - 2 α + {θ}_{m}\end{matrix} & ( 3 )\end{matrix}$$

As shown in FIG. 4B, when θᵢₙ of two extremely rays respectively are 0° and a critical angle, light should all be reflected by the reflective side surface 120a. Extending the two reflected rays, a crossing point (i.e. virtual emission point, Pv) is produced. All the collimated light could be regarded as emitting from the virtual emission point (Pv). According to the theory of Mirror, the virtual emission point (Pv) appeared to be the same distance from the mirror surface as the real emission point (Pr). Hence, h₁ in FIG. 4B can be calculated by formulas (4) to (5):

d=BD (4)

h₁=d cos(β₀), β₀=90°−2α (5)

In addition, a distance between the virtual emission point (Pv) and the second surface 110b of the basic layer 110 is defined as h. A distance between the incident bottom surface 120b and the virtual emission point (Pv) is defined as h₁. Heights of the reflective convex-part 120 and the basic layer 110 respectively are h₂ and h₃, where h is the sum of h₁, h₂ and h₃.

h=h₁+h₂+h₃ (6)

Focus f and back focus length (BFL) of the collimating lens are shown in FIG. 4C. According to the theory of a focusing lens, rays transmitted from the focus f would be collimated to parallel rays by the lens. Therefore, when the focus f of the collimating lens is substantially coincided with the virtual emission point (Pv), it can exhibit good collimating effect. According to Snell's law, the back focus length (BFL) can be derived by formulas (7) to (9):

sin(θ₁)=n₂ sin(θ₂) (7)

cos(θᵢ)=(R−t)/R (8)

BFL=y×tan(90−θ₁+θ₂) (9)

In order to achieve better collimation, BFL is set to a length same as h to let the focus f of the collimating lens coincide the virtual emission point (Pv). Hence, the heights (h₂ and h₃) of the reflective convex-part 120 and the basic layer 110, respectively, can be calculated.

BFL=h (10)

Therefore, in one embodiment, the BFL of the collimating lens is substantially equal to the sum of the height h₃ of the basic layer 110, the height h₂ of the reflective convex-part 120 and the distance h₁ between the incident bottom surface 120b and the virtual emission point (Pv). In one embodiment, the focus f of the collimating lens is substantially coincided with the virtual emission point (Pv). Further, the focus f of the collimating lens is located in the light guide plate 200.

In one embodiment, a backlight module 10 including the optical film 100 is also provided. The optical film 100 is disposed on a transmittance element such as a light guide plate 200, but not limited thereto. In one embodiment, the optical film 100 is adhered on the light guide plate 200. Specifically, the incident bottom surface 120b of the optical film 100 is adhered and fixed on a top surface of the light guide plate 200. For example, the optical film 100 is heated to become thermoplastic state and then put on the light guide plate 200 under vacuum to adhere the light guide plate 200. Alternatively, an adhesive layer (not shown) is formed on the light guide plate 200, and the optical film 100 is then adhered on the adhesive layer under vacuum. The embodiments of the optical film 100 and the light guide plate 200 can be the same as the description of FIGS. 1A-1B, 2 and 3.

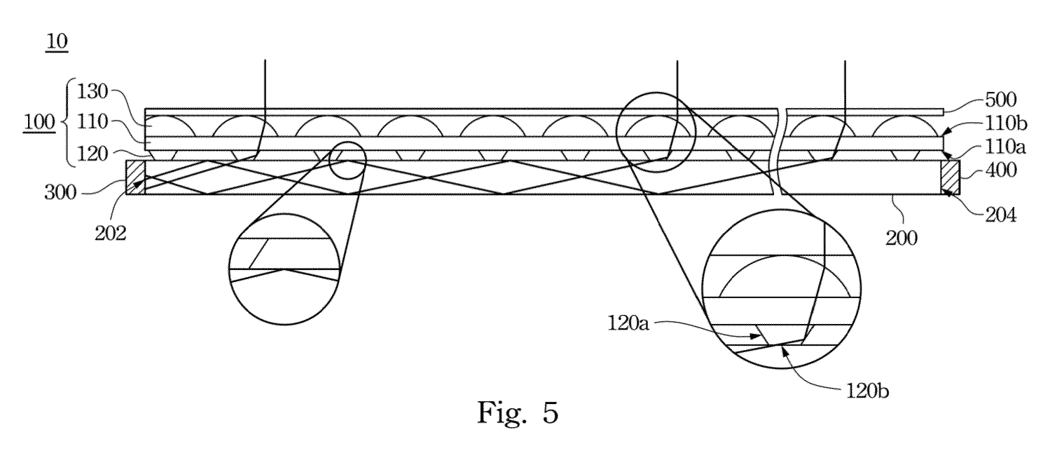

In one embodiment, the backlight module 10 further includes a first light source 300 disposed next to a first side 202 of the light guide plate 200, as shown in FIG. 5. The first side 202 is the incident surface. The first light source 300 can be a cold cathode fluorescent lamp (CCFL) or a light emitting diode (LED). When the backlight module 10 has a single-sided light source, a mirror can be disposed next to a second side 204 located opposite the first side 202.

When light is emitted by the first light source 300 into the light guide plate 200, it totally reflects and moves forward until contacts the incident bottom surface 120b. Subsequently, light directly enters the reflective convex-part 120 because the light guide plate 200 and the optical film 100 are made of the same material. When light contacts the reflective side surface 120, it totally reflects and transmits to the collimating part 130. Finally, light is converged, collimated and emitted to outside by the collimating part 130.

In one embodiment, the backlight module 10 further includes a diffusion sheet 500 disposed on the collimating parts 130, which is used to cover defects of the optical film 100.

In one embodiment, the backlight module 10 further includes a second light source 400 disposed next to a second side 204 of the light guide plate 200. In other words, the backlight module 10 includes a double-sided light source system to enhance brightness.

As mentioned above, the backlight module 10 may include a single-sided light source or a double-sided light source, free of any reflector and any second prism.

### EXAMPLES

The following Examples are provided to illustrate certain aspects of the present disclosure and to aid those of skill in the art in practicing this disclosure. These Examples are in no way to be considered to limit the scope of the disclosure in any manner.

### Example 1

### Backlight Module with Optical Film (Single-Sided Light Source)

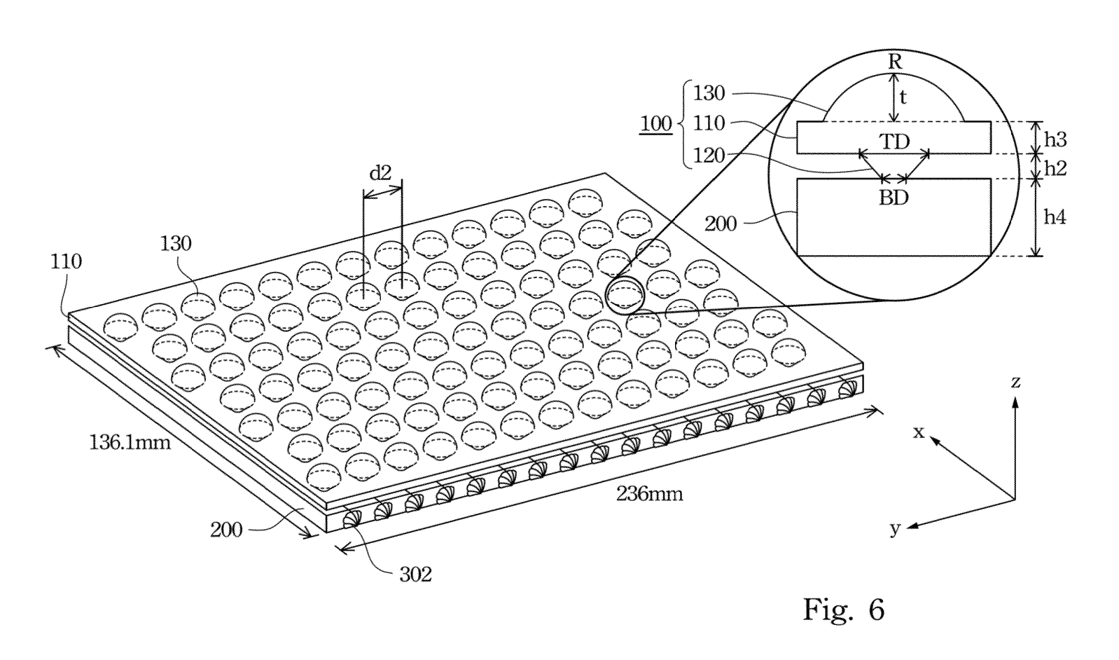

FIG. 6 is a schematic diagram of a backlight module according to one embodiment of the present disclosure. The light source is composed of 18 light emitting diodes (Nichia NESW155T) 302, which belongs to the typical Lambertian light source. An incident surface of the light guide plate 200 is next to the light emitting diodes 302. A mirror is disposed opposite the incident surface to enhance illumination efficiency.

The light guide plate 200 and the optical film 100 are made of the same material, poly(methylmethacrylate), to avoid generation of Fresnel loss. The length and the width of the optical film 100 respectively are 236 mm and 136.1 mm. There are plurals periodically arranged reflective convex-parts 120 and collimating parts 130 disposed on the relative surfaces of the optical film 100. The shapes of the reflective convex-part 120 and the collimating part 130 respectively are a truncated cone and a half sphere.

First, the angle α is set as 51.34°, and the size of each of the portion of the optical film 100 can be then calculated by the formulas mentioned above. In the reflective convex-part 120, the diameter BD of the incident bottom surface is 0.042 mm, and the diameter TD of the upper surface is 0.122 mm. The height h₂ is 0.05 mm.

The height h₄ of the light guide plate 200 and the height h₃ of the basic layer 110 respectively are 1.4 mm and 0.16 mm.

According to formulas (6) and (10), h is the sum of h₁, h₂ and h₃, and h is equal to BFL. Therefore, the radius R of the collimating part 130 is 0.15 mm, and the thickness t thereof is 0.09 mm. The minimum distance d₂ between a central point of the collimating part and a central point of another collimating part close thereto is 0.22 mm.

In addition, in order to reduce the visual impact of the microstructure, a diffusion sheet is added on the optical film to cover defects.

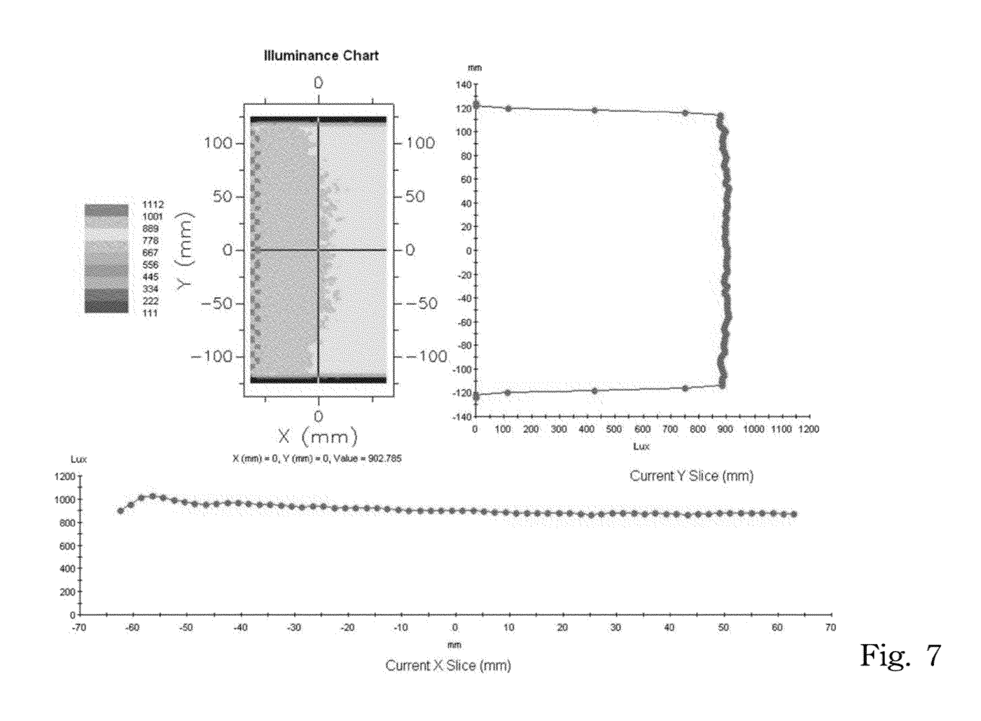

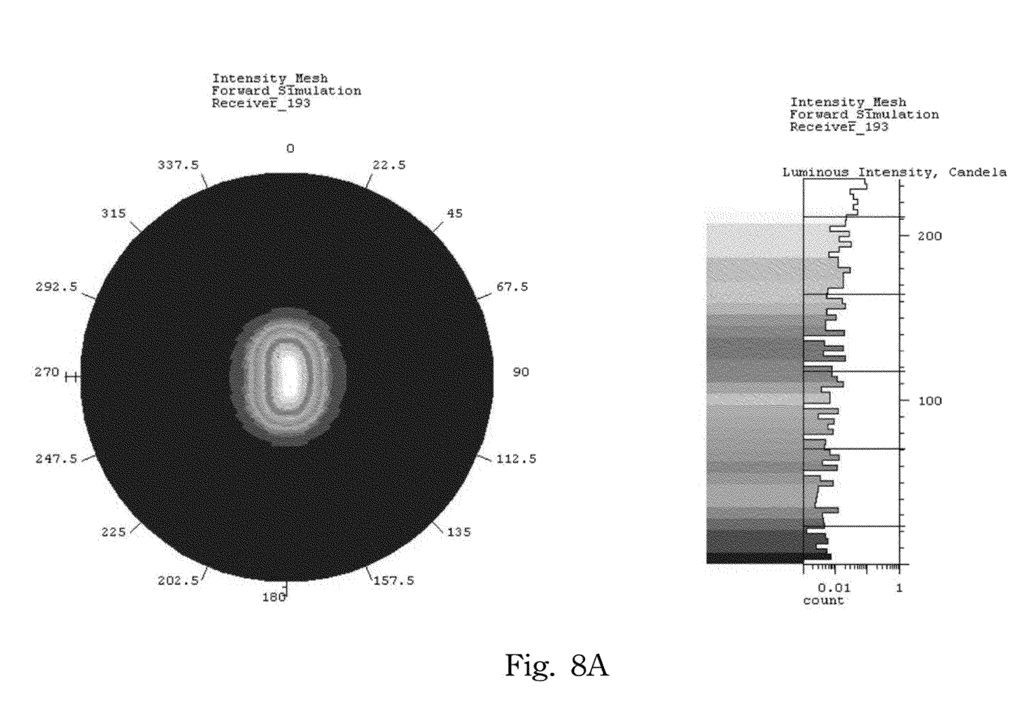

An optical simulation software LightTools is used to simulate illumination distribution of the backlight module including the diffusion sheet, as shown in FIG. 7. The uniformity of the backlight module is 89%, which is calculated by a nine points measuring method.

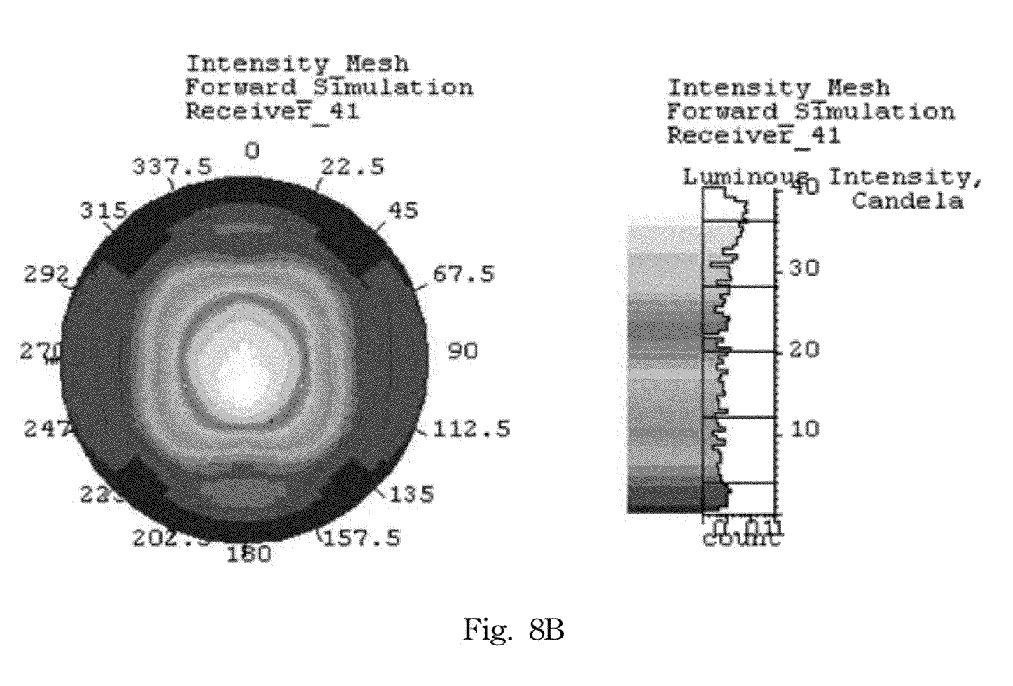

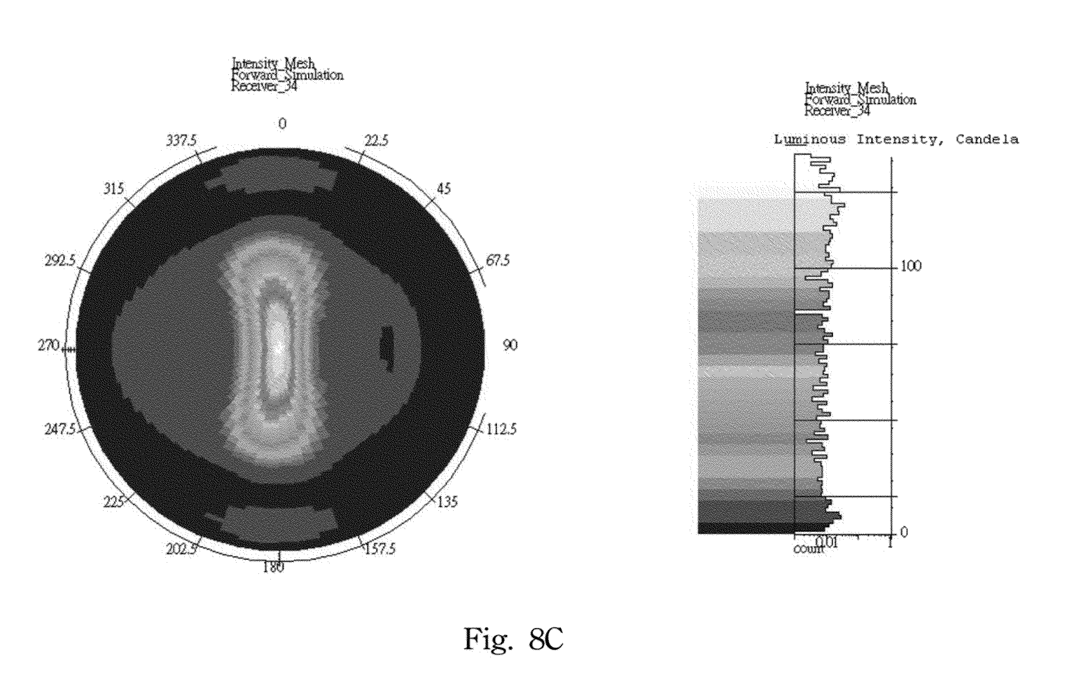

FIG. 8A is an intensity chart of a backlight module containing the diffusion sheet. Such backlight module can effectively collimate rays in horizontal and vertical directions.

### Comparison 1: Conventional Backlight Module

The conventional backlight module (N101L6-L0B) is one of products produced by CHIMEI INNOLUX CORP., which has been widely applied in notebooks.

FIG. 8B is an intensity chart of the conventional backlight module. The collimation in horizontal and vertical directions still needs to be improved.

### Comparison 2: Conventional Backlight Module

The backlight module having V-cut design is disclosed by J. W. Pan et al. in 2011 (J. W. Pan and C. W. Fan “High luminance hybrid light guide plate for backlight system application” Opt. Express 19 20079-20087 (2011)).

FIG. 8C is an intensity chart of the backlight module having the V-cut design. The V-cut design can be utilized to collimate rays in horizontal direction. Nevertheless, such backlight module cannot well collimate rays in the vertical direction. Therefore, if the backlight module needs to collimate the rays in the vertical direction, an additional prism should be disposed on the light guide plate.

As shown in FIGS. 8A-8C, comparing the backlight module having the optical film (Example 1) to the conventional backlight module (Comparison 1) and the backlight module having the V-cut design (Comparison 2), the backlight module having the optical film exhibits excellent collimation in vertical and horizontal directions.

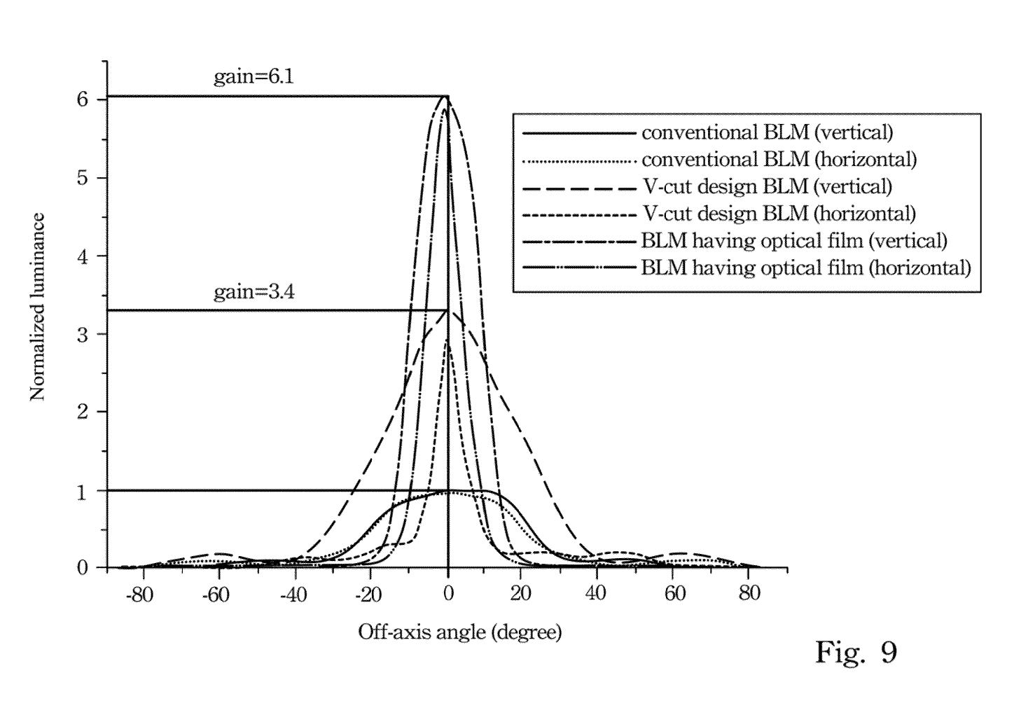

FIG. 9 is a relationship diagram between normalized luminance and off-axis angle of three backlight modules. The on-axis luminance of the conventional backlight module is used to normalize luminance of other backlight modules. By the experimental results, the on-axis luminance of the backlight module having the optical film and the backlight module having V-cut design respectively are 6.1 times and 3.4 times to the conventional backlight module.

The half-luminance angles of the backlight module having the optical film in vertical and horizontal directions respectively are 10° and 6°. The half-luminance angles of the backlight module having V-cut design in the vertical and the horizontal directions respectively are 17° and 5°. The half-luminance angles of the conventional backlight module in the vertical and the horizontal directions respectively are 21° and 21°. The numbers of the components of the backlight modules and the optical properties thereof are listed in Table 1.

TABLE 1
the backlight module having the optical film, the conventional backlight
module and the backlight module having the V-cut design

| | | | | Normalized | Half-luminance |
|---|---|---|---|---|---|
| | Number of | Number | Number of | on-axis | angle |
| | reflector | of prism | diffuser | luminance | (Vertical/Horizontal) |
| Example 1 | 0 | 0 | 1 | 6.1 | 10°/6° |
| Comparison 1 | 1 | 2 | 2 | 1.0 | 21°/21° |
| Comparison 2 | 1 | 1 | 1 | 3.4 | 17°/5° |

As shown in Table 1, the backlight module having the optical film has fewer components and exhibits excellent collimation in horizontal and vertical directions.

### Example 2

### Backlight Module with Optical Film (Double-Sided Light Source)

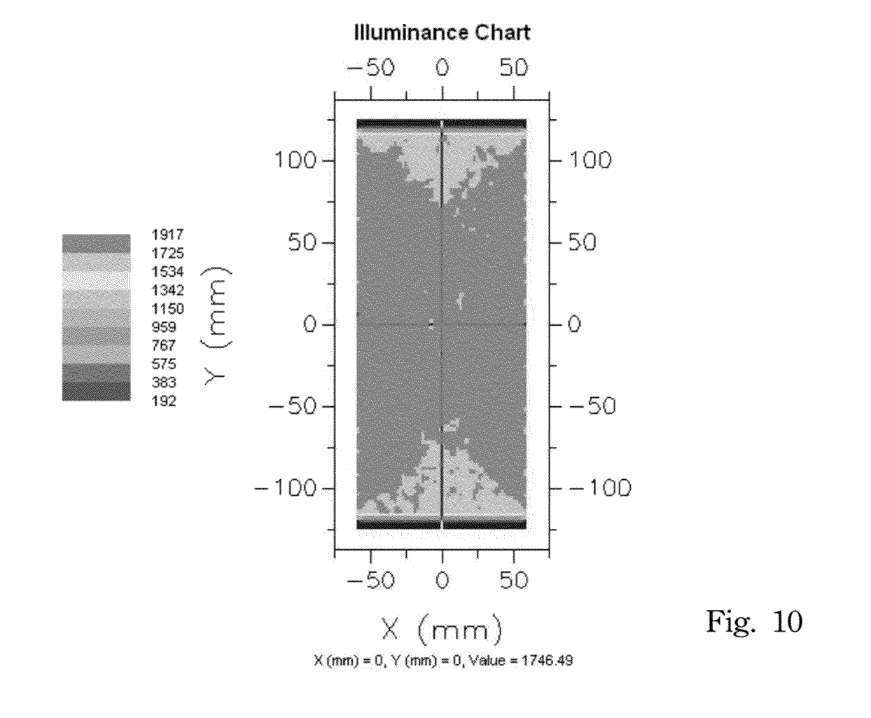

The backlight module with a double-sided light source is to add a light source into backlight module of Example 1 and dispose mirrors behind the two light sources. The optical simulation software LightTools is used to simulate illumination distribution of the backlight module with a double-sided light source, as shown in FIG. 10. The uniformity of such backlight module is 96.5%, which is calculated by the nine points measuring method.

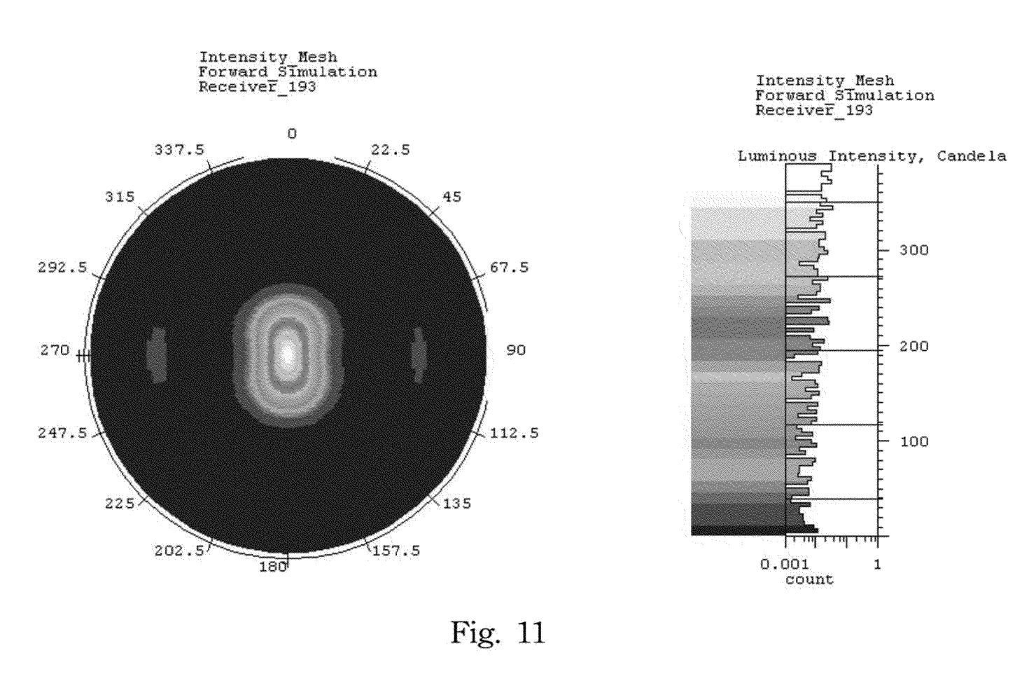

FIG. 11 is an intensity chart of a backlight module with a double-sided light source. Such backlight module also can effectively collimate rays in horizontal and vertical directions.

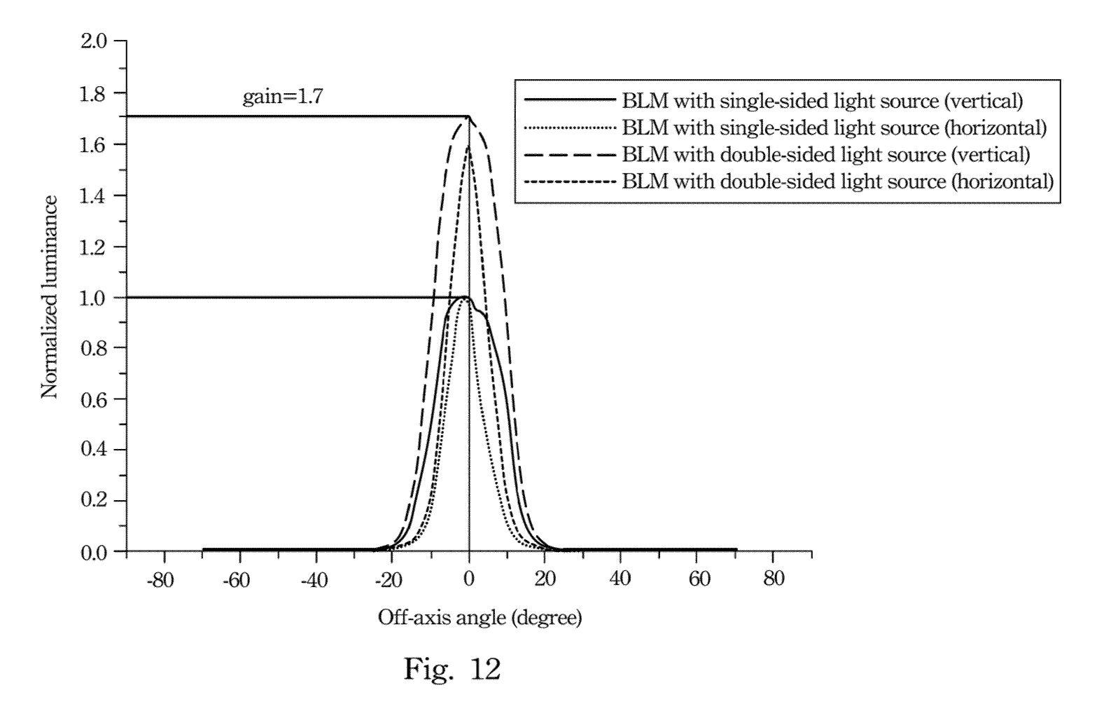

FIG. 12 is a relationship diagram between normalized luminance and off-axis angle of both a backlight module with a single-sided light source and a backlight module with a double-sided light source. Comparing the on-axis luminance of the two backlight modules, the on-axis luminance of the backlight module with the double-sided light source is 1.7 times to the on-axis luminance of the backlight module with the single-sided light source. Therefore, in the backlight module with the double-sided light source, one light source can be opened (that is, power saving mode) if someone does not need so high brightness. When two light sources are opened (that is, high brightness mode), the backlight module can exhibit higher collimation and better uniformity of the luminance. Consequently, the modes of the backlight module with the double-sided light source can be selected according to different needs to avoid energy consumption.

### Tolerance of Reflective Convex-Part and Collimating Part

In the process for manufacturing the optical film, a bit error, which may cause the reflective convex-part not fully align the collimating part, may occur. Such optical film may effect the direction of light transmission, and thus the collimation may out of expectation. Consequently, the inventors analyzed the effect of a bit error between the reflective convex-part and the collimating part.

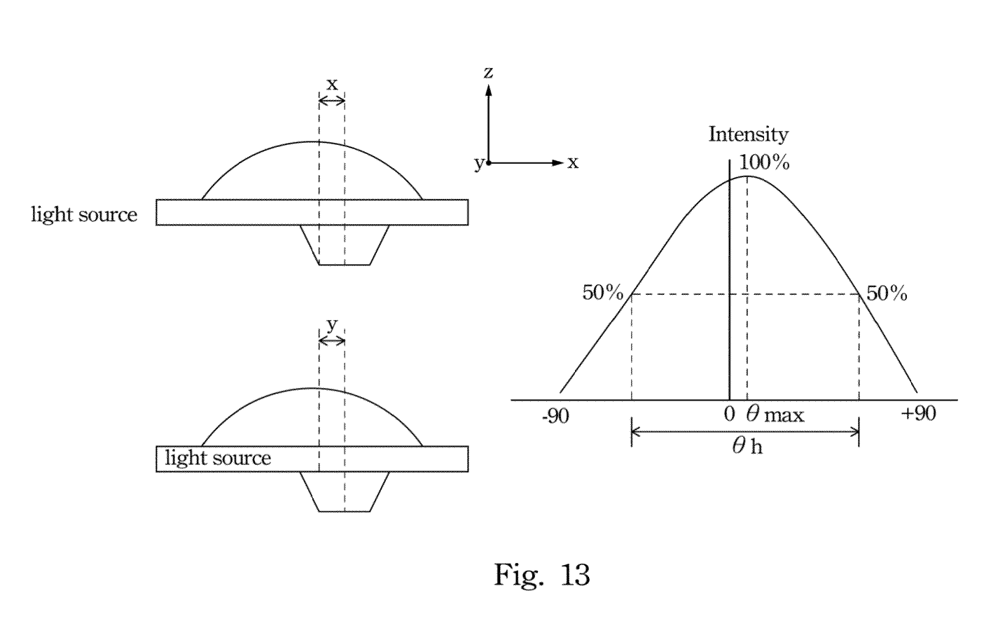

In FIG. 13, the displacement between a central point of the reflective convex-part and a central point of the collimating part in vertical and horizontal directions respectively are defined as parameters X and Y. θₘₐₓ is the angle when light intensity reaches the maximum value. θₕ is an absolute value of the difference between the two angles when the light intensity is reduced to 50%. X and Y are both set to −20 to +20 μm to observe changes of θₘₐₓ and θₕ.

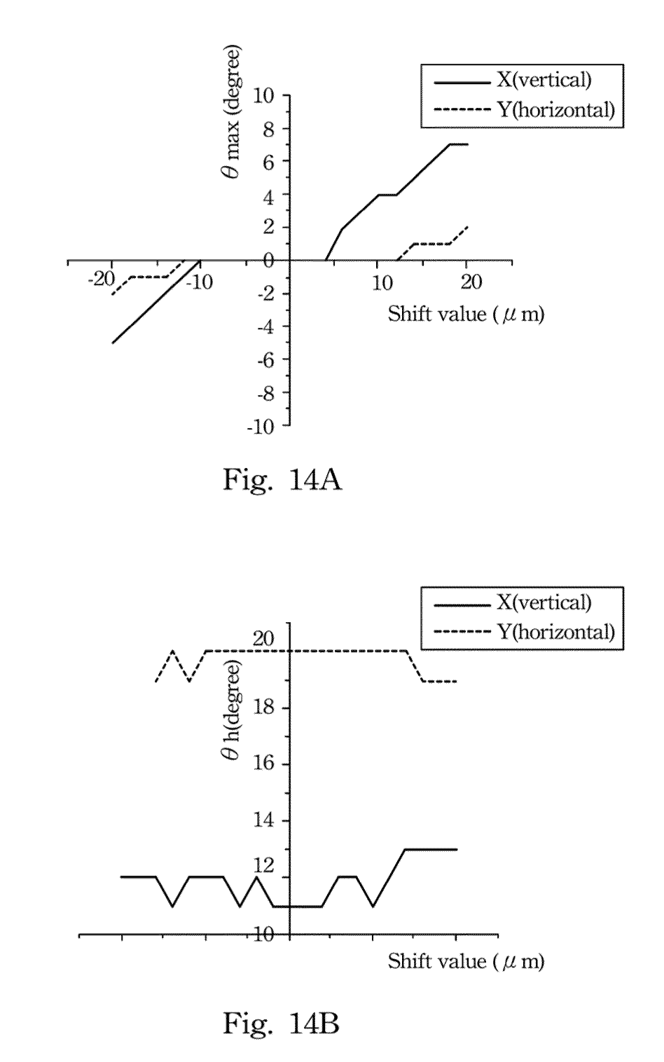

If the main light is emitted in straight direction, θₘₐₓ is 0°. As shown in FIG. 14A, θₘₐₓ is 0° when x is −10 to +4 μm or y is −12 to +12 μm. In other words, under the ranges mentioned above, the main light emitted by the backlight module belongs to straight direction. Comparing to the range in the vertical direction, the range in horizontal direction has greater tolerance. The light intensity in vertical and horizontal directions of the side-edge backlight module is not consistent, such that the tolerances in the two directions are also different.

If the collimation is high, θₕ is small. As shown in FIG. 14B, θₕ in vertical and horizontal directions respectively are 11 to 13 degrees and 19 to 20 degrees. As mentioned above, when x and y respectively shift to −20 to +20 μm, it may slightly effect the collimation.

As mentioned above, the optical film exhibits excellent collimation, and the backlight module having the optical film free of any reflector and any second prism. Also, a single-sided light source or a double-sided light source can be used in such backlight module. Further, comparing to a non-periodically arranged microstructure, periodically arranged microstructure is easy to manufacture and the process cost is low. It is because precise alignment technology should be employed when manufacturing the non-periodically arranged microstructure.

In summary, the optical film exhibiting high collimation in the embodiments of the present invention has been developed to reduce the number of the components within the backlight module, and thus the optical film can be effectively applied in the backlight modules of such mobile phones or notebooks.

Although the present disclosure has been described in considerable detail with reference to certain embodiments thereof, other embodiments are possible. Therefore, the spirit and scope of the appended claims should not be limited to the description of the embodiments contained herein.

It will be apparent to those ordinarily skilled in the art that various modifications and variations may be made to the structure of the present disclosure without departing from the scope or spirit of the disclosure. In view of the foregoing, it is intended that the present disclosure cover modifications and variations thereof provided they fall within the scope of the following claims.

What is claimed is:

1. An optical film for disposing on a transmittance element, the optical film comprising:
a basic layer having a first surface and a second surface;
a plurality of periodically arranged reflective convex parts disposed on the first surface of the basic layer, wherein each of the reflective convex-parts comprises:
at least one reflective side surface, wherein an included angle between the reflective side surface and the first surface is from 20 to 80 degrees; and
an incident bottom surface substantially parallel to the first surface to contact the transmittance element; and
a plurality of periodically arranged collimating parts disposed on the second surface of the basic layer, and the reflective convex-parts are respectively corresponded to the collimating parts,
wherein, in each corresponding pair of the reflective convex-part and the collimating part, the reflective convex-part has a central axis substantially coinciding with a central axis of the collimating part.

2. The optical film of claim 1, wherein the basic layer, the reflective convex-parts, the collimating parts and the transmittance element are made of a same material.

3. The optical film of claim 1, wherein the reflective convex-part has a surface contacting the first surface less than a surface of the collimating part which contacts the second surface.

4. The optical film of claim 1, wherein the surface of the reflective convex-part contacting the first surface is greater than the surface of the incident bottom surface.

5. The optical film of claim 1, wherein the included angle between the reflective side surface and the first surface is from 40 to 60 degrees.

6. The optical film of claim 1, wherein the reflective convex-part is a truncated taper.

7. The optical film of claim 6, wherein the truncated taper is a truncated cone or a truncated pyramid.

8. The optical film of claim 1, wherein the collimating part is a collimating lens.

9. The optical film of claim 8, wherein the collimating lens is a spherical lens.

10. The optical film of claim 8, wherein the collimating lens has a focus substantially coinciding a virtual emission point.

11. The optical film of claim 8, wherein the collimating lens has a back focus length being the sum of a height of the basic layer, a height of the reflective convex-part, and a distance between the incident bottom surface and the virtual emission point.

12. The optical film of claim 1, wherein the collimating parts are spatially arranged.

13. The optical film of claim 1, wherein a distance between the collimating part and another collimating part close thereto is from 0 to 0.1 mm.

14. The optical film of claim 1, wherein a distance between a central point of the collimating part and a central point of another collimating part close thereto is from 0.2 to 0.3 mm.

15. The optical film of claim 1, wherein the collimating parts are arranged side-by-side.

16. The optical film of claim 1, further comprising a diffusion sheet disposed on the collimating parts.

17. A backlight module comprising an optical film according to claim 1, wherein the transmittance element is a light guide plate.

18. The backlight module of claim 17, further comprising a first light source next to a first side of the light guide plate.

19. The backlight module of claim 18, further comprising a second light source next to a second side of the light guide plate, wherein the second surface is disposed opposite the first side.

20. The backlight module of claim 17, further comprising a diffusion sheet disposed on the collimating parts of the optical film.
